(19) United States
(12) Patent Application Publication
(10) Pub. No.: US 2026/0072977 A1
(43) Pub. Date: Mar. 12, 2026

(54) Real-Time Content Fact Check and Resource Suggestions

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/826,977

(22) Filed: Sep. 6, 2024

(51) Int. Cl. G06F 16/35

(52) U.S. Cl. CPC G06F 16/355

(57) ABSTRACT

Systems and methods for real-time fact checking and resource suggestions for user-generated content drafting can include obtaining the user-generated content data, identifying fact statements within the user-generated content data, performing a classification of the fact statements, determining relevant passages from the web resources, and providing annotations of the user-generated content that include the factual classifications for the fact statements along with resource suggestions. The classification can be determined based on identifying relevant resources and processing the fact statements and the relevant resources with a machine-learned generative language model.

### FIELD

The present disclosure relates generally to content fact checking and resource suggestion. More particularly, the present disclosure relates to determining factual statements within user generated content and checking one or more resources to determine a factual validity of the determined factual statements.

### BACKGROUND

The internet can facilitate the rapid dissemination and amplification of information; however, the content may be provided without any significant evaluations of accuracy or truthfulness. In particular, the mass adoption of social media can further influence the quantity and spread of information via algorithms designed to put information before as many users as possible without verifying the authenticity or impact of the information. With the large quantity of information, truthful or otherwise, available to a user, creating and contributing information that is valuable and accurate may be a difficult task. Additionally, publishing inaccurate information can be received with hostility by other users even if intentions were honest, and that hostility may dissuade users from otherwise contributing.

Moreover, understanding search results from a search results page can be difficult as titles and text snippets may provide limited information that may not be associated with the user's interest, which can lead to a time consuming web resource review that may not yield the desired information. Obtaining additional information on web resources can be difficult, which may include an additional search that may or may not identify relevant information.

Additionally, obtaining user insights can be difficult. In particular, users may struggle to determine which words to use. Additionally, the words may not be directed to a point-of-interest for other users and/or may not be abundant enough to generate desired results.

### SUMMARY

Aspects and advantages of embodiments of the present disclosure will be set forth in part in the following description, or can be learned from the description, or can be learned through practice of the embodiments.

One example aspect of the present disclosure is directed to a computing system for real-time content feedback and suggestion. The system can include one or more processors and one or more non-transitory computer-readable media that collectively store instructions that, when executed by the one or more processors, cause the computing system to perform operations. The operations can include obtaining, via a link notes interface, user-generated content data. The user-generated content data can include a text string input by a user. In some implementations, the link notes interface can include a user interface that is configured to receive inputs to generate user generated link notes to index with web resources. The operations can include processing the user-generated content data with a language model to identify one or more fact statements within the text string input. The language model may have been trained to parse text and identify text segments associated with a fact being asserted. The operations can include generating a factuality classification for each of the one or more fact statements based on querying one or more knowledge databases. Generating the factuality classification can include comparing details from one or more result data sets of the one or more knowledge databases to the one or more fact statements. The operations can include determining a resource suggestion based on the one or more result data sets. The resource suggestion can include information on a topic associated with the one or more fact statements. The operations can include providing the factuality classification and the resource suggestion for display via the link notes interface.

In some implementations, generating the factuality classification can include generating one or more queries based on the one or more fact statements, determining the one or more result data sets from the one or more knowledge databases are responsive to the one or more queries, and generating the factuality classification based on a comparison between the one or more fact statements and the one or more result data sets. The operations can include iteratively performing fact statement identification, factuality classification determination, resource suggestion determination, and feedback display as additional user generated content inputs are received. In some implementations, the user-generated content data can include a link note. The link note can be descriptive of a comment left by one or more other users linked to a web resource. The link note can be provided for display when the web resource is provided as a search result.

In some implementations, the user-generated content data can be composed as a link note for a particular web resource. The operations can include determining the particular web resource includes details associated with the one or more fact statements. The factuality classification can be determined based at least in part on the details within the particular web resource. The details of the particular web resource can be weighted based on a determined credibility level of the particular web resource.

In some implementations, the operations can include processing the resource suggestion and the one or more fact statements to determine one or more relevant passages of the resource suggestion and providing the one or more relevant passages of the resource suggestion for display. The operations can include processing the one or more result data sets and the one or more fact statements with the generative language model to determine the factuality classification and a reasoning text string and providing the reasoning text string for display. The reasoning text string can be descriptive of reasoning for the factuality classification.

In some implementations, the one or more result data sets of the one or more knowledge databases can be determined based on (i) determining the one or more result data sets of the one or more knowledge databases are associated with the topic of the one or more fact statements and (ii) determining the one or more result data sets are within a recency threshold. The operations can include performing optical character recognition on one or more images of the user-generated content data.

Another example aspect of the present disclosure is directed to a computer-implemented method. The method can include obtaining, by a computing system including one or more processors and via a user interface, user-generated content data. The user-generated content data can include a text string input by a user. The user interface can be configured to receive inputs to compose user-generated content. The method can include processing, by the computing system, the user-generated content data with a machine-learned generative language model to identify one or more fact statements within the text string input. The machine-learned generative language model may have been tuned to parse text and identify text segments associated with a fact being asserted. The method can include generating, by the computing system, a factuality classification for each of the one or more fact statements based on querying one or more knowledge databases. Generating the factuality classification can include comparing details from one or more result data sets of the one or more knowledge databases to the one or more fact statements. The method can include determining, by the computing system, a resource suggestion based on the one or more result data sets. The resource suggestion can include information on a topic associated with the one or more fact statements. The method can include providing, by the computing system, the factuality classification and one or more relevant passages of the resource suggestion for display via the user interface.

In some implementations, the method can include processing, by the computing system, the resource suggestion and the one or more fact statements with the machine-learned generative language model to determine the one or more relevant passages. The factuality classification can include at least one of true, false, or undetermined. The factuality classification may include a binary classification label and a confidence score. In some implementations, the method can include processing the resource suggestion and the one or more fact statements to determine the one or more relevant passages of the resource suggestion. The one or more result data sets can be determined based on being associated with the topic associated with the one or more fact statements and one or more credibility scores associated with the one or more resources of the one or more result data sets.

Another example aspect of the present disclosure is directed to one or more non-transitory computer-readable media that collectively store instructions that, when executed by one or more computing devices, cause the one or more computing devices to perform operations. The operations can include obtaining, via a link notes interface, user-generated content data. The user-generated content data can include a text string input by a user. In some implementations, the link notes interface can include a user interface that is configured to receive inputs to generate user generated link notes to index with web resources. The operations can include processing the user-generated content data with a language model to identify one or more fact statements within the text string input. The language model may have been trained to parse text and identify text segments associated with a fact being asserted. The operations can include generating one or more factuality classifications for the one or more fact statements based on querying one or more knowledge databases. Generating the one or more factuality classifications can include comparing details from one or more result data sets of the one or more knowledge databases to the one or more fact statements. The operations can include determining one or more resource suggestions based on the one or more result data sets. The resource suggestions can include information on one or more topics associated with the one or more fact statements. The operations can include providing one or more annotations with the user-generated content data. The one or more annotations can indicate one or more positions of the one or more fact statements. The one or more annotations can include the one or more factuality classifications and the one or more resource suggestions.

In some implementations, the one or more annotations can include underlining the text segments associated with the fact being asserted. The one or more annotations can include a pop-up overlay interface window that includes the one or more factuality classifications and the one or more resource suggestions. The one or more annotations can include highlighting the text segments associated with the fact being asserted.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example fact checking system according to example embodiments of the present disclosure.

FIG. 2 depicts a block diagram of an example knowledge database-based fact checking system according to example embodiments of the present disclosure.

FIG. 3 depicts a flow chart diagram of an example method to perform fact checking of user-generated content data according to example embodiments of the present disclosure.

FIG. 4 depicts an illustration of an example link note interface according to example embodiments of the present disclosure.

FIG. 5 depicts an illustration of an example resource suggestion interface according to example embodiments of the present disclosure.

FIG. 6 depicts an illustration of an example graphical card interface according to example embodiments of the present disclosure.

FIG. 7 depicts a flow chart diagram of an example method to perform resource suggestion according to example embodiments of the present disclosure.

FIG. 8 depicts a flow chart diagram of an example method to perform real-time user-generated content annotation according to example embodiments of the present disclosure.

FIG. 9A depicts a block diagram of an example computing system that performs factual statement determination and factual classification according to example embodiments of the present disclosure.

FIG. 9B depicts a block diagram of an example computing system that performs factual statement determination and factual classification according to example embodiments of the present disclosure.

FIG. 10 is a flow chart diagram illustrating an example method for training a machine-learned model according to example implementations of aspects of the present disclosure.

FIG. 11 is a block diagram of an example processing flow for using machine-learned model(s) to process input(s) to generate output(s) according to example implementations of aspects of the present disclosure.

FIG. 12 is a block diagram of an example sequence processing model according to example implementations of aspects of the present disclosure.

FIG. 13 is a block diagram of an example technique for populating an example input sequence for processing by a sequence processing model according to example implementations of aspects of the present disclosure.

FIG. 14 is a block diagram of an example model development platform according to example implementations of aspects of the present disclosure.

FIG. 15 is a block diagram of an example training workflow for training a machine-learned model according to example implementations of aspects of the present disclosure.

FIG. 16 is a block diagram of an inference system for operating one or more machine-learned model(s) to perform inference according to example implementations of aspects of the present disclosure.

FIG. 17 is a block diagram of an example networked computing system according to example implementations of aspects of the present disclosure.

FIG. 18 is a block diagram of an example computing device according to example implementations of aspects of the present disclosure.

FIG. 19 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for fact checking user inputs and providing resource suggestions associated with a factuality classification. For instance, a user may be writing a post, message, note, and/or other content item composition on their device and, as the user writes, the text can be checked for inaccuracies both in grammar and truthfulness of factual statements. As an example, a user may be composing a post relating to hummingbirds, and the user may include the sentence “the hummingbird is the smallest animal ever!” As the user types out the sentence the statement may be identified as a factual statement and then cross-checked across different sources for accuracy. If the sentence is truthful, then no further indication or analysis may be provided. Although, in some instances, the user may receive an indication that the statement has been checked and is, in fact, truthful such as an underlining or pop-up notification indicating such. However, if the statement is inaccurate, the user may be given a notification that their statement is incorrect and may also be provided an alternative writing to correct the inaccuracy and links to reliable sources as evidence of the inaccuracy. Alternatively and/or additionally, resource suggestions may be provided regardless of the factual classification.

In some implementations, the systems and methods may include determining whether a statement written by a user is to be fact checked. For instance, a user may provide a statement of opinion, not fact, while writing in their personal journal and/or blog. While the user did write a statement, the statement may be determined as non-factual, or as an opinion, and disregarded when processing the user's writings to determine factual inaccuracies. However, if so desired, the user may be notified and/or indicated to their writing including a non-factual statement (or opinion).

In particular, the content being processed may be a link note being composed and/or viewed by the user. Link notes can provide insight on a web resource and/or may provide additional details on a topic of the web resource. The link notes can include user-generated content items and may be aggregated in a link notes interface and/or a collections interface to provide other users with reviews on web resources and/or other knowledge provided by other users. The link notes can be indexed with and/or associated with particular web resources. Link notes can include content (e.g., text, images, video, etc.) added by a user to characterize and/or describe the search result link.

Real-time fact checking and resource suggestion can be useful for real-time feedback for user-generated content, which can include fact-checking during link note preparation or other user-generated content. Real-time suggestion and fact-checking can leverage search engines, knowledge graphs, and natural language processing techniques.

Inaccuracies in link notes, social media posts, and/or other documents can spread misinformation, which can cause a propagation of inaccuracies. Additionally, the original content creator may receive backlash. Fact checking by an editor or other reviewer after drafting can be helpful; however, the review and revisions can be time consuming, tedious, and may lead to heavy rewrites.

User-generated content (e.g., text of a link note) can be processed to identify facts within the user-generated content, which can then be processed to determine whether the facts are true and may provide references for providing credibility. User interface elements can be utilized to help users understand what facts are identified and true. By having real-time fact checking and resource suggestions, the user can be notified in real-time when there is a potential inaccuracy, which can avoid building off the original inaccuracy, provide immediate correction, and/or improve credibility.

Moreover, the internet can facilitate the rapid dissemination and amplification of information; however, the content may be provided without any significant evaluations of accuracy or truthfulness. In particular, the mass adoption of social media can further influence the quantity and spread of information via algorithms designed to put information before as many users as possible without verifying the authenticity or impact of the information. With the large quantity of information, truthful or otherwise, available to a user, creating and contributing information that is valuable and accurate may be a difficult task. Additionally, publishing inaccurate information can be received with hostility by other users even if intentions were honest, and that hostility may dissuade users from otherwise contributing. Furthermore, generative language models being introduced to consumer markets can facilitate the creation of information that can include hallucinations, which may propagate the spread of misinformation. By the time content is published information, the damage misinformation may cause may have already been done. Therefore, fact checking during the composition stage of content items can prevent the dissemination and spread of misinformation.

Accordingly, aspects of the present disclosure can be directed to systems and methods for fact checking user generated content, in real time. For instance, user-generated content (e.g., text within a social media post) can be processed to identify factual statements present within the user-generated content, which can then be processed to determine whether the statements are true and, in addition, may provide references to prove credibility and/or to provide a drafting aid. Additionally and/or alternatively, user interface elements can be utilized to help users understand what facts are identified and/or whether the identified facts are determined to be true. For instance, factual statements in user generated content may be underlined in green if they are truthful, and/or have a strong truthful scoring, and underlined in red if they are false, and/or have a low truthful scoring. By utilizing real-time fact checking and reference suggestions, before publication, the user can be notified in real-time when there may be a potential inaccuracy to avoid building off the original inaccuracy, provide immediate correction, and/or improve credibility.

Fact-checking and resource suggestions can be implemented for fact-checking link notes, social media post drafts, documents being drafted, and/or other content items. Resource suggestions can provide resources to verify the content of a content item, which can provide credibility and/or supplementary information.

The systems and methods of the present disclosure can provide a number of technical effects and benefits. As one example, the system and methods can provide fact checking in real time as a user is drafting their content. The user may be provided with indications of the factual statements present within their draft, the truthfulness of their statements, and reliable sources indicating for or against the statements they make. Additionally and/or alternatively, the user may be suggested rewrites and/or alternative language to correct any inaccuracies in their drafting. The process of fact checking and correcting a user's writing as the writing is provided, and prior to publication, may reduce the time processing takes to generate publishable and credible content, reduce the resources required to generated said content (e.g., elimination of second eyes review), and generate credibility within user generated content that utilizes aspects of the present disclosure during the drafting process. In some implementations, the systems and methods may cache fact statement determinations, factual classifications, and/or resource suggestions, such that as iterative processing is performed, the cached information can be leveraged to reduce the redundant processing. For example, the system may iteratively process user-generated content as the user continues to provide inputs; however, the previous determinations may be leveraged such that only the new inputs need to be classified. Additionally and/or alternatively, the system may leverage the cached resource suggestions for performing the new classifications such that the system does not need to perform another knowledge database query if the resource is determined to have the relevant content.

The systems and methods of the present disclosure provide a number of technical effects and benefits. As one example, the system and methods can provide an interactive user interface that can be utilized to generate prompts and obtain user input data. In particular, the systems and methods disclosed herein can leverage one or more machine-learned models to generate resource suggestions and factual classifications. For example, a generative model can process user data, content data, and/or other context data to determine a request for information action is to be performed. Additionally and/or alternatively, the generative model may generate a prompt to request information based on the user data, content data, and/or other context data. The prompt can be provided to the user, a user input can be received, and a link note may be generated and stored.

The systems and methods disclosed herein addresses a problem generated by computing systems obtaining, processing, and transmitting data from a plurality of databases from a plurality of sources. The immense volume of data available to users can provide potential for misinformation, misdirection, and/or lack of verification. Text snippets, titles, and/or example images in a search results interface may provide some details on contents of a web resource; however, information from other users can provide further insight on topic, trustworthiness, and/or what to expect, which can be leveraged to reduce instances of irrelevant web resources being navigated and reviewed by the user.

Another example of technical effect and benefit relates to improved computational efficiency and improvements in the functioning of a computing system. For example, the systems and methods disclosed herein can leverage note generation to provide an interface that provides information on links that may mitigate tedious search result review by providing user-based validation. The reduced volume of follow-up queries and the reduced volume of page redirects can reduce latency at the user device and can reduce search engine computational cost.

With reference now to the Figures, example embodiments of the present disclosure will be discussed in further detail.

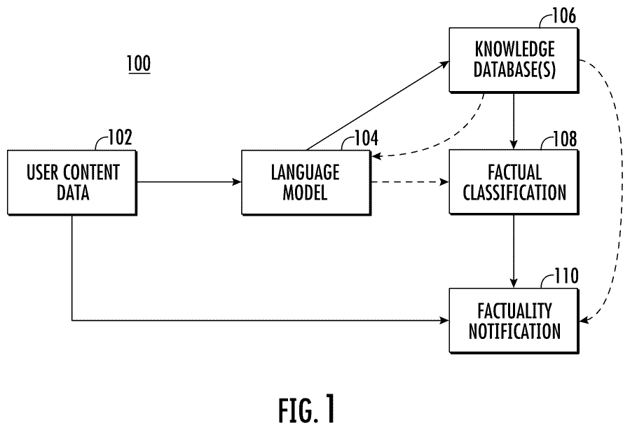

FIG. 1 depicts a block diagram of an example fact checking system 100 according to example embodiments of the present disclosure. In some implementations, the fact checking system 100 is configured to receive, and/or obtain, a set of user-generated content data 102 descriptive of a user input (e.g., a user textual input, a voice input, and/or other user input). As a result of receipt of the user-generated content data 102, generate, determine, and/or provide a factuality notification 110 that includes a factuality classification of factual statements identified in the received user-generated content data 102. Thus, in some implementations, the fact checking system 100 can include a language model 104 that is operable to process the user-generated content data 102 and determine any factual statements present within the user-generated content data 102. For example, the language model 104 can determine, from the user-generated content data 102, assertions and/or statements of fact and segment them from the remainder of the user-generated content data 102 (e.g., statements of opinion or fiction).

The fact checking system 100 can leverage the factual statements discerned by the language model 104 and query knowledge database(s) 106 to determine a factual classification 108 of said factual statements. In some implementations, the details obtained from the knowledge database 106 may be provided to the language model 104 to generate the factual classification 108. Additionally and/or alternatively, in some implementations, the language model 104 may process the details obtained from the knowledge database 106 and the user-generated content data 102 to generate the factual classification 108. The factual classification 108 may be provided to a user, by the fact checking system 100, via a factuality notification 110. In some implementations, the factuality notification 110 can include the user-generated content data 102, one or more resources from the knowledge database(s) 106, and/or the factual classification. For instance, the factuality notification may be a graphical pop-up (and/or another type of user interface element) including the user-generated content data 102, hyperlinks to one or more web resources from the knowledge database(s) 106, and/or the factuality classification 18. The hyperlinks to one or more web resources from the knowledge database(s) 106 may be provided in the factuality notification 110 as evidence to support the factual classification 108 determined by the fact checking system 100 and/or to provide a guide for further drafting.

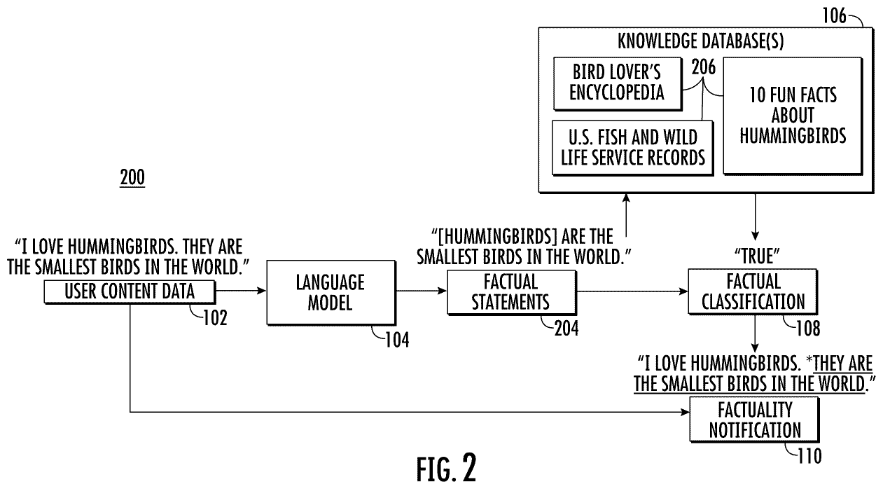

FIG. 2 depicts a block diagram of an example knowledge database-based fact checking system 200 according to example embodiments of the present disclosure. The knowledge database-based fact checking system 200 is similar to fact checking system 100 of FIG. 1 except that fact checking system 200 further includes user-generated content data annotation with identification of factual statements 204 and/or factual classification 108 indicator(s). The factual statements 204 may be output from the language model 104 based on the provided user-generated content data 102. For example, the user-generated content data 102 may include textual data, such as “I love Hummingbirds, they are the smallest birds in the world.” and may be provided (and/or transmitted) to the language model 104 to determine the presence of any statements and/or assertions of fact within the user-generated content data 204. The language model may output identifiers and/or indicators of the factual statements 204 determined by parsing and/or semantically understanding the user-generated content data 102 (e.g., the factual statement “[Hummingbirds] are the smallest birds in the world.”).

The factual statements 204 may be provided to the knowledge database(s) 106 to determine the factual classification 108. For instance, the factual statements 204, “[Hummingbirds] are the smallest birds in the world.” may be provided to and/or cross-referenced with the knowledge database(s) 106 to determine a factual classification 108 of “True” based on the several factual sources 206 within the knowledge database(s) 106. The knowledge database(s) 106 may include several factual sources 206 that may be queried and/or provided to the language model 104 to determine the factual classification 108. As examples, encyclopedias, scientific journals, government records, and/or similar trusted factual sources may be stored in the knowledge databases(s) 16 as the factual sources 206. In some implementations, a search engine may be leveraged to determine a plurality of resources that may be determined to be associated with the factual statement 204. The credibility and/or trustworthiness of the plurality of resources may then be evaluated generally and/or with respect to the topic to determine one or more particular resources to utilize for the factual classification 108 determination. Alternatively and/or additionally, the knowledge database-based fact checking system 200 may leverage a classification model and/or classification heads of the language model 104 to determine the factual classification 108. For example, the classification model and/or the classification heads of the language model 104 may have been trained, tuned, and/or configured to perform classifications on particular facts and/or a plurality of different topics without leveraging web resources. In some implementations, the language model 104 (e.g., a large language model) may perform an initial classification based on processing the user-generated content data 102. The initial classification may include a classification label (e.g., true, partially true, false, undetermined, and/or contested) along with a confidence level. If the confidence level is above a threshold level, the initial classification may be output as the factual classification 108. One or more resources may then be determined and retrieved that back the determination. If the confidence level is below a threshold level, one or more knowledge databases 106 may then be queried to determine one or more resources associated with the topic of the factual classification. The one or more resources and the factual statement 14 may then be processed with the language model 104 (and/or a separate machine-learned model) to generate a refined classification, which can then be output as the factual classification 108.

The factual classification 108 may be provided to a user via the factuality notification 110. The factuality notification 110 may include the factual classification 108 and the user-generated content 12. The factuality notification 110 can take a variety of forms and include several different types of information. For instance, the factuality notification 110 can include a graphical overlay on top of the user-generated content 12 when a user hovers over the user-generated content. The factuality notification 110 can also include one or more visual indicators within the user-generated content 12 being displayed. As an example, the factuality notification 110 can include an underline below the user-generated content 12 (and/or a color-coded highlight) that was determined to be a factual statement 204, such as “they are the smallest birds in the world” within the user-generated content 12 “I love Hummingbirds. They are the smallest birds in the world.” Upon hovering over the underlined user-generated content 12 a graphical pop-up may be displayed as part of the factuality notification 110 providing the factual classification 108 of the underlined content and including one or more resources from the factual resources 206 that was used to determine the factual classification 108.

The knowledge database-based fact checking system 200 can leverage one or more machine-learned models for performing the factual statement 204 determination, the knowledge database 106 querying, the factual classification 108 determination, and/or the factual notification 110 generation. For example, factual statement 204 determination may include parsing the user-generated content data 102, performing semantic understanding and/or classification of each parsed segment, and/or generating context-aware factual statement 204 that may include rewriting the user-generated content data 102 to include a synthesized factual statement 204. The parsing, semantic understanding, and/or statement generation may be performed by different models and/or may be performed by a singular language model 104 (e.g., a large language model). The knowledge database 106 querying may include generating a query based on the factual statement 14, generating a query embedding based on the generated query, determining search results, evaluating the search results, and/or generating synthesized factual passage based on one or more particular search results determined to be relevant and credible. The synthesized factual passage may then be utilized for the factual classification 108. The query generation, embedding generation, search result determination, search result evaluation, and/or factual passage generation may be performed by one or more machine-learned models, which may include leveraging a search engine, a ranking engine, a language model, an embedding model, encoders, decors, and/or other models.

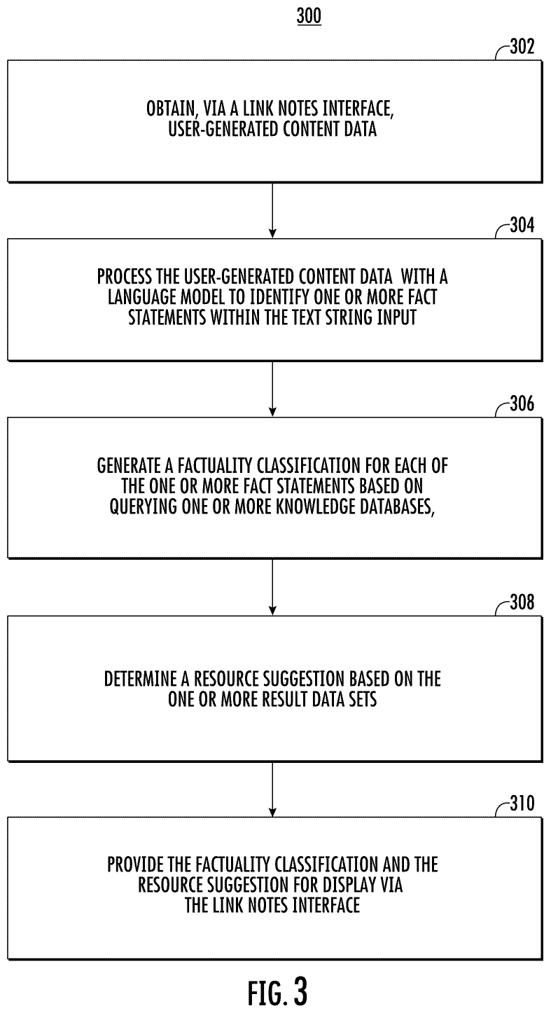

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain, via a link notes interface, user-generated content data. The user-generated content data can include a text string input by a user. The link notes interface can include a user interface that is configured to receive inputs to generate user generated link notes to index with web resources. In some implementations, the user-generated content data is being composed as a link note for a particular web resource. In some implementations, the system can determine the particular web resource includes details associated with the one or more fact statements. The factuality classification can be determined based at least in part on the details within the particular web resource. In some implementations, the details of the particular web resource may be weighted based on a determined credibility level of the particular web resource. Additionally, and/or alternatively, optical character recognition may be performed on one or more images of the user-generated content data. For example, the user-generated content data may include one or more images and/or videos that may be processed to determine whether the one or more images and/or videos include factual statements and whether the factual statements are true.

At 304, the computing system can process the user-generated content data with a language model to identify one or more fact statements within the text string input. The language model can be trained and/or tuned to parse text and identify text segments associated with a fact being asserted. The one or more fact statements can be determined by parsing the text, rewriting the segments into complete statements, classifying the statements as a fact statement or an opinion statement, and/or classifying the segments. The statements may be generated based on performing a plurality of sequential word predictions based on the details of the segment and the context provided within the other segments of the user-generated content data. In some implementations, the language model may include a vision language model that may be utilized to process image(s) and/or video(s) of the user-generated content data to generate image captions that can then be parsed and classified to identify fact statements within visual data.

At 306, the computing system can generate a factuality classification for each of the one or more fact statements based on querying one or more knowledge databases. Generating the factuality classifications can include comparing details from one or more result data sets of the one or more knowledge databases to the one or more fact statements. In some implementations, generating the factuality classifications can include generating one or more queries based on the one or more fact statements, determining the one or more result data sets from the one or more knowledge databases are responsive to the one or more queries, and generating the factuality classification based on a comparison between the one or more fact statements and the one or more result data sets. The factual classification can include a classification label (e.g., true, false, undetermined, partially true, and/or contested) and/or a confidence level. In some implementations, the confidence level may determine whether the end output includes a binary true or false or whether the undetermined label is provided. In some implementations, a classification model and/or classification heads of the generative language model may be utilized for the classification.

At 308, the computing system can determine a resource suggestion based on the one or more result data sets. The resource suggestion can include information on a topic associated with the one or more fact statements. In some implementations, the one or more result data sets of the one or more knowledge databases are determined based on (i) determining the one or more result data sets of the one or more knowledge databases are associated with the topic of the one or more fact statements and (ii) determining the one or more result data sets are within a recency threshold. The resource suggestion determination may include determining a particular resource passage to provide for display with the factual classification. The resource suggestion may include a resource title, a resource deep link, a relevant passage, and/or other details.

At 310, the computing system can provide the factuality classification and the resource suggestion for display via the link notes interface. The factuality classification can be provided for display via one or more annotations, which may include a color-coded underlines, circles, and/or highlights (e.g., red for false, green for true, and/or blue for undetermined). In some implementations, opinion statements may be indicated via a different annotation.

In some implementations, the computing system can additionally iteratively perform fact statement identification, factuality classification determination, resource suggestion determination, and feedback display as additional user generated content inputs are received. Additionally, and/or alternatively, in some implementations, the computing system can process the resource suggestion and the one or more fact statements to determine one or more relevant passages of the resource suggestion and provide the one or more relevant passages of the resource suggestion for display. Additionally, and/or alternatively, the computing system can process the one or more result data sets and the one or more fact statements with the generative language model to determine the factuality classification and a reasoning text string and provide the reasoning text string for display. The reasoning text string can be descriptive of reasoning for the factuality classification.

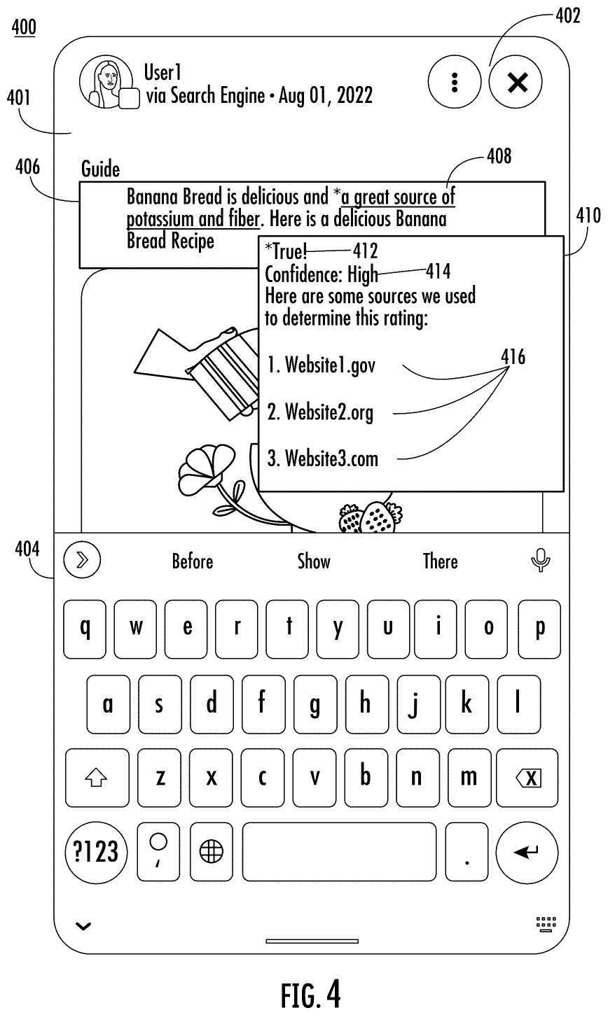

FIG. 4 depicts an illustration of an example link note interface 400 according to example embodiments of the present disclosure. The link note interface 400 can include a current link note 401, one or more link note interface elements 402 for managing the link note 401, and a user input interface 404, such as a keyboard. In some implementations, the link note 401 can include one or more text boxes 406 which may include user generated content data. As an example, a user may be adding text to the link note 401 via the one or more text boxes 406. As the user provides content to the link note 401 via the user input interface 404. In some implementations, one or more fact statements 408 may be identified within the one or more text boxes 406. For the one or more fact statements 408 identified, a factual interface element 410 may be provided within the link notes interface 400.

The factual interface element 410 may include a variety of elements relating to each fact statement 408 identified within the link note 401. In some implementations, example elements can be a factual classification 412, a confidence score 414 associated with the factual classification 412, and/or one or more fact resource suggestions 416. The factual classification 412 can be, for example, True, False, or indeterminate and can be associated with the fact statement 408. The confidence score 414 can be a confidence score related to the factual classification 412. For instance, the confidence score 414 can be a confidence of the system in the determination of the factual classification 412. More specifically, the confidence score 414 can be an indicator of how correct or accurate the system probability prediction is descriptive of for the factual classification 412 of the fact statement 408. The one or more fact resource suggestions 416 can be provided as hyperlinks (and/or deep links) to the fact resources themselves. The one or more fact resource suggestions 416 can be a variety of web resources used by the system to determine the factual classification 412 and confidence score 414. For instance, the factual classification 412 and confidence score 414 can be determined based on a credibility determination of each of the one or more fact resource suggestions 416. In some implementations, the one or more fact resource suggestions 416 can be a particular web resource associated with the link note 401. The confidence score 414 can be a determination of a confidence level of the one or more predictions (e.g., how confident the model is with a given classification). The confidence score 414 may be descriptive of a probability determination, credibility of a resource, and/or an ambiguity of the fact statement 408 and/or the resources.

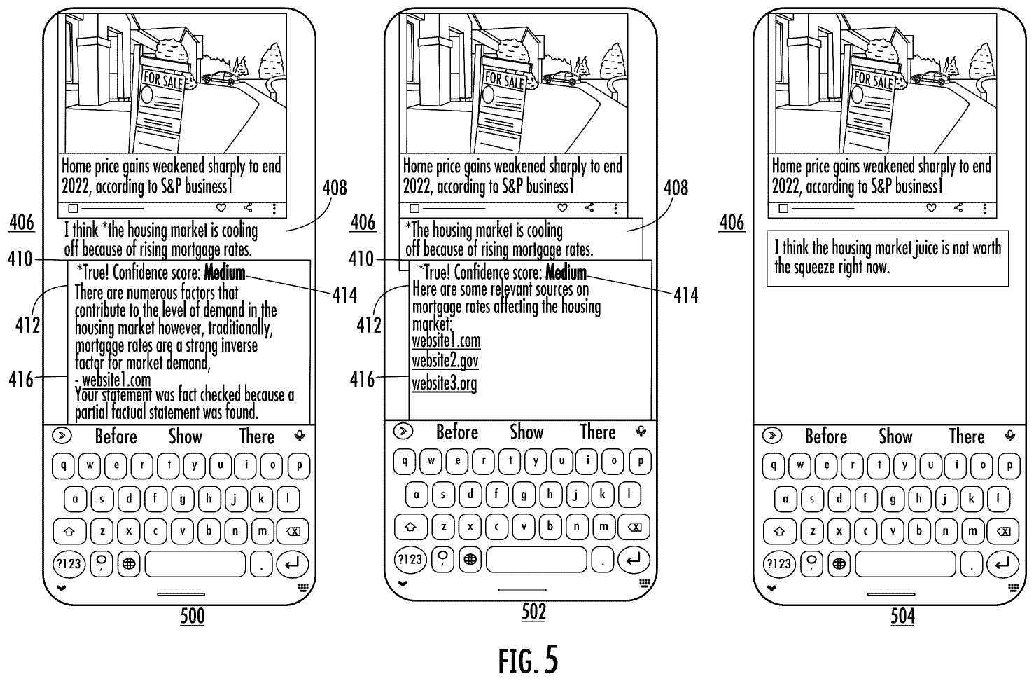

FIG. 5 depicts illustrations of example resource suggestion interfaces 500, 502, and 504 according to example embodiments of the present disclosure. The example resource suggestion interfaces 500, 502, and 504 can provide various example embodiments relating to determination of factual statements within user generated content data. For instance, the resources suggestion interfaces 500, 502, and 504 can include one or more text boxes 406 which can include user generated content, such as text data. In some implementations, such as interfaces 500 and 502, the user generated content may include one or more fact statements 408. For each of the one or more fact statements 408, a factual interface element 410 may be displayed.

The factual interface elements 410 may include a variety of interface elements as shown in FIG. 4. For instance, the factual interface elements 410 may include a factual classification 412, a confidence score 414, and/or one or more fact resource suggestions 416. Additionally and/or alternatively, the factual interface elements 410 may include an explanation (or description) of the various elements within the factual interface elements 410 and/or an explanation (or description) of the factual interface elements 410 themselves.

In some implementations, and as depicted in example resource suggestion interface 500, the factual interface elements 410 may be generated based on identified partial factual statements. Additionally and/or alternatively, and as depicted in example resource suggestion interface 504, no factual interface element may be generated when no factual statement is depicted within user generated content data, such as the user generated content data provided within the one or more text boxes 406. For instance, when the user generated content data is determined to include an opinion with no supplemental and/or complementary fact statements. In some implementations, the systems and methods may provide resource suggestions without a factual classification 412 in instances when only opinions are determined.

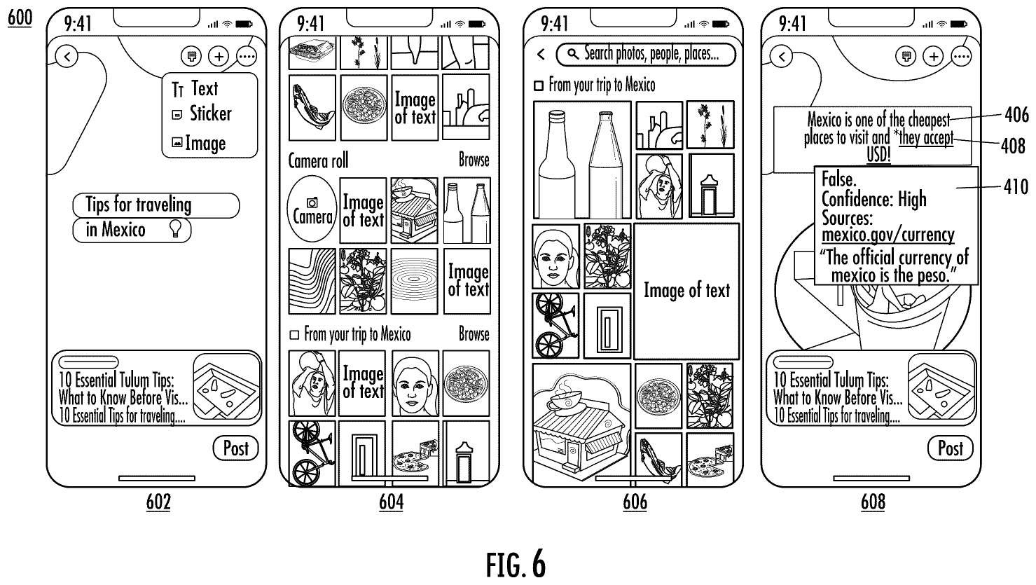

FIG. 6 depicts illustrations of an example graphical card interface 600 according to example embodiments of the present disclosure. The graphical card interface 600 can include several different graphical card interfaces 602, 604, 606, and 608 where the system may identify one or more factual statements. For instance, the system may identify factual statements, such as factual statement 408, in any of the graphics, text, or images depicted in the different graphical card interfaces 602, 604, 606, and 608.

As an example, a factual statement 408 may be identified within one or more text boxes 406 of a graphical card, such as the graphical card 608. The factual statement 408 may be identified using one or more graphical elements such as underlining, asterisk, bolding, or italicizing. In practice, any graphical indicator may be used to distinguish the identified factual statement 408. For each factual statement 408 identified, a factual interface element 410 may be displayed, as depicted in FIG. 4.

For example, FIG. 6 depicts factual classification and resource suggestion interface elements that may be provided for display as a user generates a graphical card link note. The graphical card link note can include text, images, widgets, and/or other contents. In some implementations, the images suggested in 604 and/or 606 may be suggested based on the content of the user-generated content, the web resource, and/or the resource suggestions. The images may be from local storage of the user computing device, an image gallery application associated with the user, the web resource associated with the link note, the resource suggestions, and/or other image databases.

In some implementations, the images in the link note graphical cards may be processed to perform a fact statement associated with whether the image is artificially generated (e.g., artificial intelligence created), whether the image depicts an accurate representation of a historical event, whether the image has been altered, and/or whether there is another potential inaccuracy or misleading aspect.

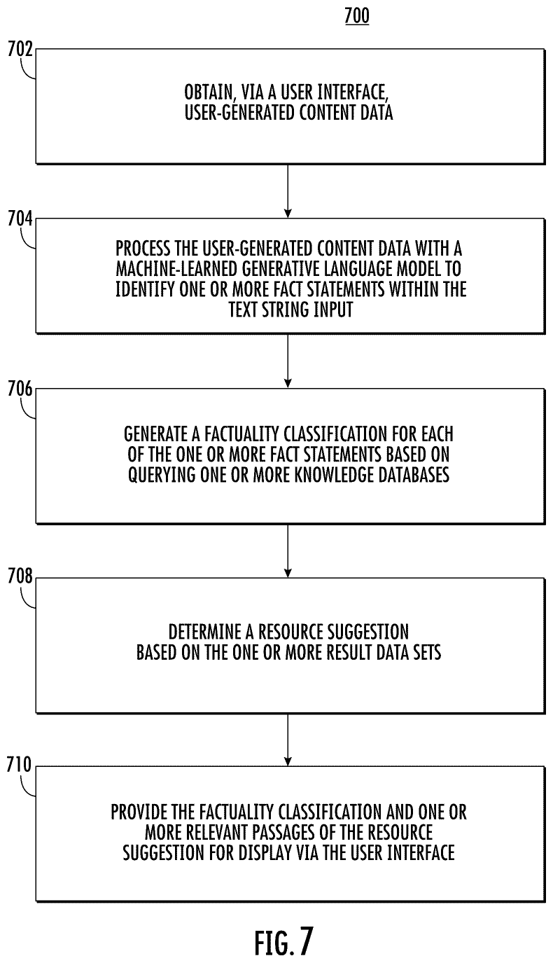

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain, via a user interface, user-generated content data. The user-generated content data can include a text string input by a user. Additionally and/or alternatively, the user interface can be configured to receive inputs to compose user-generated content. The user interface may include a freeform text input box, an upload tool, voice command retrieval tool, and/or other interface features.

At 704, the computing system can process the user-generated content data with a machine-learned generative language model to identify one or more fact statements within the text string input. The machine-learned generative language model can be tuned to parse text and identify text segments associated with a fact being asserted. The identification may include performing tokenization with a machine-learned tokenizer.

At 706, the computing system can generate a factuality classification for each of the one or more fact statements based on querying one or more knowledge databases. Generating the factuality classification can include comparing details from one or more result data sets of the one or more knowledge databases to the one or more fact statements. In some implementations, the factuality classification can include at least one of true, false, or undetermined. Additionally, in some implementations, the factuality classification can include a binary classification and a confidence score. In some implementations, the one or more result data sets can be determined based on being associated with the topic associated with the one or more fact statements and one or more credibility scores associated with the one or more resources of the one or more result data sets. Alternatively and/or additionally, the classification may be determined via one or more machine-learned models without querying knowledge databases and/or conditioned based on the resources of the knowledge database.

At 708, the computing system can determine a resource suggestion based on the one or more result data sets. The resource suggestion can include information on a topic associated with the one or more fact statements. In some implementations, the computing system can process the resource suggestion and the one or more fact statements with the machine-learned generative language model to determine the one or more relevant passages. Additionally, and/or alternatively, the computing system can process the resource suggestion and the one or more fact statements to determine the one or more relevant passages of the resource suggestion.

At 710, the computing system can provide the factuality classification and one or more relevant passages of the resource suggestion for display via the user interface. The factual classification and the one or more relevant passages may be provided for display via a pop-up interface element, which may be provided for display upon determination and/or upon a user hovering over the relevant portion of the user-generated content data.

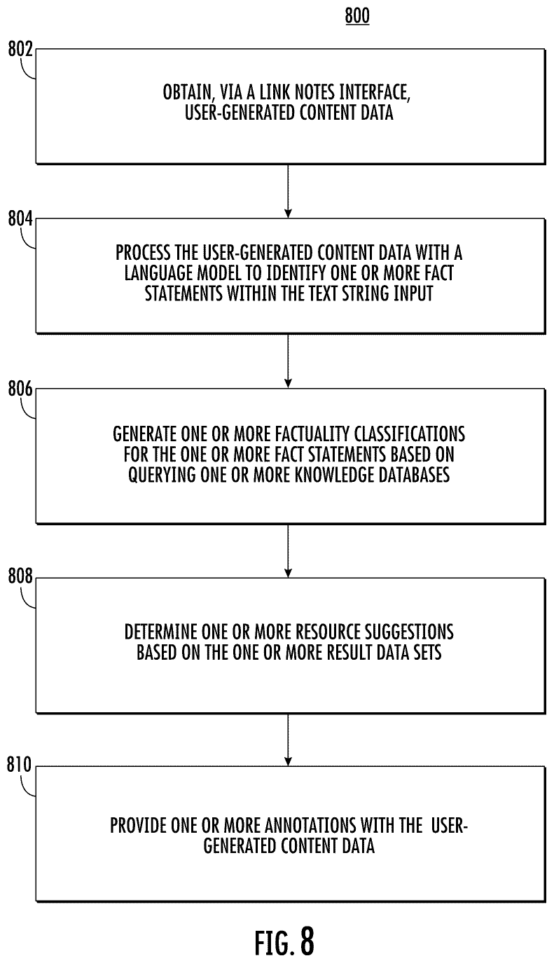

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain, via a link notes interface, user-generated content data. The user-generated content data can include a text string input by a user and the link notes interface can include a user interface that is configured to receive inputs to generate user generated link notes to index with web resources. The user-generated content data may include image data that may be processed with a vision language model to generate a text string descriptive of the features depicted within the image(s).

At 804, the computing system can process the user-generated content data with a language model to identify one or more fact statements within the text string input. The language model can be trained to parse text and identify text segments associated with a fact being asserted. The language model may include one or more encoders, one or more decoders, an embedding model, a parsing engine, a tokenizer, a semantic understanding model, and/or one or more other machine-learned models.

At 806, the computing system can generate one or more factuality classifications for the one or more fact statements based on querying one or more knowledge databases. Generating the one or more factuality classifications can include comparing details from one or more result data sets of the one or more knowledge databases to the one or more fact statements. The one or more knowledge databases may be queried based on one or more knowledge graphs and/or one or more machine-learned task graphs. The one or more knowledge databases can be associated with a search engine and may include a plurality of different web resources from a plurality of different domains.

At 808, the computing system can determine one or more resource suggestions based on the one or more result data sets. The resource suggestions can include information on one or more topics associated with the one or more fact statements. The resource suggestions may be determined by the language model, a search engine, and/or other models.

At 810, the computing system can provide one or more annotations with the user-generated content data. The one or more annotations can indicate one or more positions of the one or more fact statements and can include the one or more factuality classifications and the one or more resource suggestions. In some implementations, the one or more annotations can include underlining the text segments associated with the fact being asserted. Additionally, and/or alternatively, the one or more annotations can include a pop-up overlay interface window that includes the one or more factuality classifications and the one or more resource suggestions and/or highlighting the text segments associated with the fact being asserted.

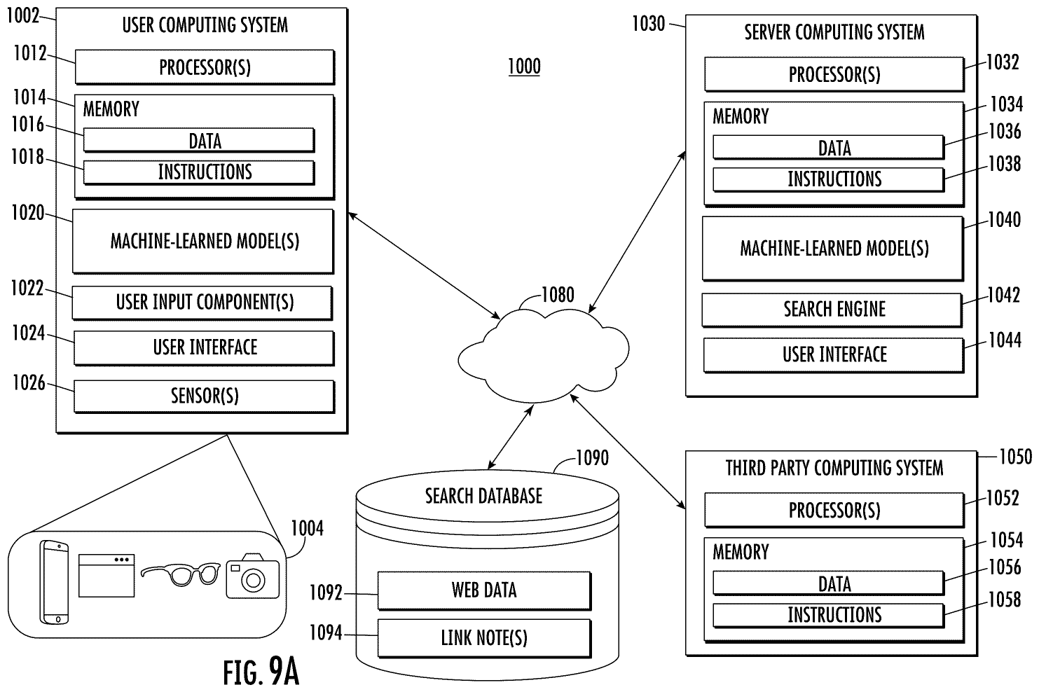

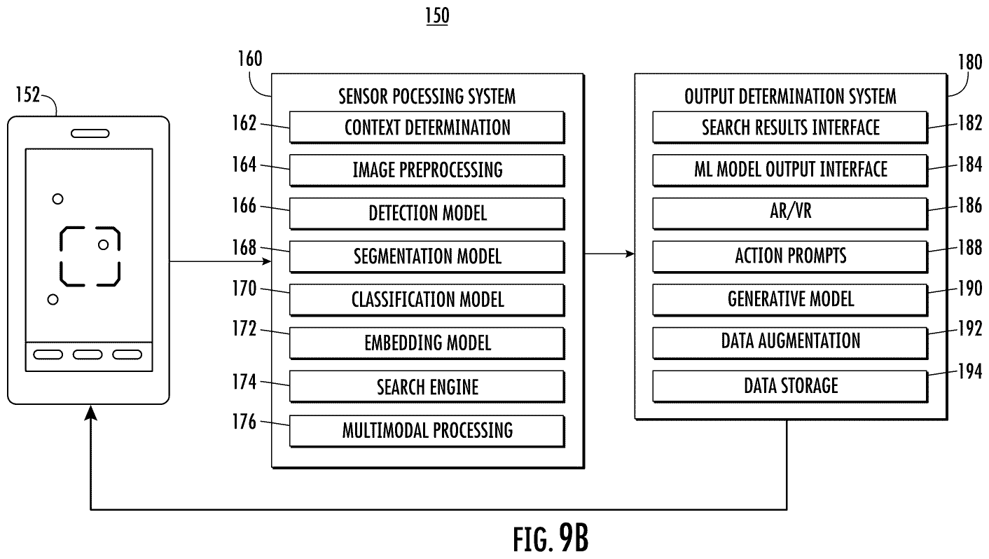

FIG. 9A depicts a block diagram of an example computing system 1000 that performs factual statement determination and factual classification according to example embodiments of the present disclosure. The system 1000 includes a user computing system 1002, a server computing system 1030, and/or a third party computing system 1050 that are communicatively coupled over a network 1080. Additionally and/or alternatively, the user computing system 1002, a server computing system 1030, and/or a third party computing system 1050 can leverage the network 1080 to access and search a search database 1090 to perform one or more search processing tasks. In some implementations, the search database 1090 may be part of and/or communicatively connected to the server computing system 1030.

The user computing system 1002 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing system 1002 to perform operations.

In some implementations, the user computing system 1002 can store or include one or more machine-learned models 1020. For example, the machine-learned models 1020 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1020 can be received from the server computing system 1030 over network 1080, stored in the user computing device memory 1014, and then used or otherwise implemented by the one or more processors 1012. In some implementations, the user computing system 1002 can implement multiple parallel instances of a single machine-learned model 1020 (e.g., to perform parallel machine-learned model processing across multiple instances of input data and/or detected features).

More particularly, the one or more machine-learned models 1020 may include one or more detection models, one or more classification models, one or more segmentation models, one or more augmentation models, one or more generative models, one or more natural language processing models, one or more optical character recognition models, and/or one or more other machine-learned models. The one or more machine-learned models 1020 can include one or more transformer models. The one or more machine-learned models 1020 may include one or more neural radiance field models, one or more diffusion models, and/or one or more autoregressive language models.

The one or more machine-learned models 1020 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1020 can process image data, text data, audio data, and/or latent encoding data to generate output data that can include image data, text data, audio data, and/or latent encoding data. The one or more machine-learned models 1020 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.09368v2 (Oct. 104, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1040 can be included in or otherwise stored and implemented by the server computing system 1030 that communicates with the user computing system 1002 according to a client-server relationship. For example, the machine-learned models 1040 can be implemented by the server computing system 1030 as a portion of a web service (e.g., a viewfinder service, a visual search service, an image processing service, an ambient computing service, and/or an overlay application service). Thus, one or more models 1020 can be stored and implemented at the user computing system 1002 and/or one or more models 1040 can be stored and implemented at the server computing system 1030.

The user computing system 1002 can also include one or more user input components 1022 that receives user input. For example, the user input component 1022 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1002 can store and/or provide one or more user interfaces 1024, which may be associated with one or more applications. The one or more user interfaces 1024 can be configured to receive inputs and/or provide data for display (e.g., image data, text data, audio data, one or more user interface elements, an augmented-reality experience, a virtual reality experience, and/or other data for display. The user interfaces 1024 may be associated with one or more other computing systems (e.g., server computing system 1030 and/or third party computing system 1050). The user interfaces 1024 can include a viewfinder interface, a search interface, a generative model interface, a social media interface, and/or a media content gallery interface.

The user computing system 1002 may include and/or receive data from one or more sensors 1026. The one or more sensors 1026 may be housed in a housing component that houses the one or more processors 1012, the memory 1014, and/or one or more hardware components, which may store, and/or cause to perform, one or more software packets. The one or more sensors 1026 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1002 may include, and/or be part of, a user computing device 1004. The user computing device 1004 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1004. For example, a camera of a smartphone may be utilized to capture image data descriptive of the environment, and/or an overlay application of the user computing device 1004 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned models 1040. For example, the models 1040 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1040 are discussed with reference to FIG. 9B.

Additionally and/or alternatively, the server computing system 1030 can include and/or be communicatively connected with a search engine 1042 that may be utilized to crawl one or more databases (and/or resources) (e.g., the search database 1090). The search engine 1042 can process data from the user computing system 1002, the server computing system 1030, and/or the third party computing system 1050 to determine one or more search results associated with the input data. The search engine 1042 may perform term based search, label based search, Boolean based searches, image search, embedding based search (e.g., nearest neighbor search), multimodal search, and/or one or more other search techniques.

The server computing system 1030 may store and/or provide one or more user interfaces 1044 for obtaining input data and/or providing output data to one or more users. The one or more user interfaces 1044 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1002 and/or the server computing system 1030 can train the models 1020 and/or 1040 via interaction with the third party computing system 1050 that is communicatively coupled over the network 1080. The third party computing system 1050 can be separate from the server computing system 1030 or can be a portion of the server computing system 1030. Alternatively and/or additionally, the third party computing system 1050 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 1000 may leverage reviews and/or other user-generated content (e.g., link notes) for training and/or model-inference. For example, a user-generated link note can include details provided by a particular user discussing the web resource associated with a particular search result, which the machine-learned model (e.g., 1020 and/or 1040) can process to identify one or more predicted actions associated with that web resource. The details can include information associated with the quality of the web resource, landing pages utilized, and/or actions performed. A link note can include text provided with the search result information of a search result (e.g., the link note may be provided with the web resource title, hyperlink, and caption). In some implementations, the link note can include a multimodal user-generated content item that may include text overlayed a graphical card with one or more media content items (e.g., images and/or videos).

In training, the computing system 1000 may utilize reviews and/or other user-generated content as quality signals and/or content indicators for training the machine-learned model (e.g., 1020 and/or 1040). For example, the reviews and/or other user-generated content can include details associated with how a user utilized the web page, what they saw on the web page, and/or their review of the quality of that web resource. The computing system 1000 may process the details of the reviews and/or other user-generated content to generate labels for web resources (e.g., a machine-learned model (e.g., 1020 and/or 1040) may process the details to identify particular actions discussed in the reviews and/or other user-generated content), and the labels may then be utilized for machine-learned model training. Alternatively and/or additionally, the computing system 1000 may utilize the reviews and/or other user-generated content as input and/or for input conditioning during training. Moreover, the machine-learned model (e.g., 1020 and/or 1040) may process the reviews and/or other user-generated content during model-inference to determine, rank, and/or filter predicted actions.

Additionally and/or alternatively, the search results interface may provide one or more link notes for display with the shortcut to the resource locator. The one or more link notes may be general link notes associated with the particular web resource. Alternatively and/or additionally, the one or more link notes may be selected based on the content of the landing page associated with the shortcut (e.g., link notes associated with reserving a table may be identified and provided for display based on the shortcut being associated with a landing page for booking a table at the restaurant associated with the web resource).

In some implementations, the computing system 1000 may utilize one or more soft prompts for conditioning the one or more machine-learned models (120 and/or 1040) for downstream tasks. The one or more soft prompts can include a set of tunable parameters that can be trained (or tuned) as the parameters of the one or more machine-learned models (120 and/or 1040) are fixed. The one or more soft prompts 1024 can be trained for a specific task and/or a specific set of tasks. Alternatively and/or additionally, the one or more soft prompts 1024 may be trained to condition the one or more machine-learned models (120 and/or 1040) to perform inferences for a particular individual, one or more entities, and/or one or more tasks such that the output is tailored for that particular individual, particular entities, and/or particular task. The one or more soft prompts 1024 can be obtained and processed with one or more inputs by the one or more machine-learned models (120 and/or 1040).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 1000 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 1002 and/or the server computing system 1030 may store one or more soft prompts associated with the particular user and/or particular task. The soft prompt(s) can include a set of parameters. The user computing system 1002 and/or the server computing system 1030 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 1030 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 1050 can include one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the third party computing system 1050 to perform operations. In some implementations, the third party computing system 1050 includes or is otherwise implemented by one or more server computing devices.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The network 1080 can be utilized to access one or more search databases 1090 to perform one or more search-based tasks, which may include web searches, image searches, blockchain searches, image searches, reverse image searches, embedding searches, and/or other searches. The one or more search databases 1090 can store web data 1092 to be leveraged to determine search results relevant (e.g., responsive) to a search query. The web data 1092 can include data descriptive of uniform resource locators, content snippets, cached data, classification labels for the content of a web resource, tags, embeddings associated with web resources, knowledge graphs, titles, authors, content types, and/or other relevant data that may be indexed to determine the topic, content, sentiment, intent, and/or other features of a web resource to then be leveraged for search instances.

The web data 1092 can be leveraged to determine search results responsive to a search query. The server computing system 1030 (and/or the user computing system 1002) can then render a search results interface based on the determined search results. The search results interface can include a search result list, a search result grid, a knowledge panel, search result categories, search result tabs, and/or other user interface configurations and/or elements. The search results interface may display text (e.g., titles and text snippets), hyperlinks, images, videos, audio, animations, carousels, and/or other data.

In some implementations, the search results interface may display one or more link notes 1094 associated with the one or more search results. The one or more link notes 1094 may be associated with respective web resources that were determined to be responsive to the search query. The link notes 1094 may be stored by the search database 1090, which may include indexing the respective link notes 1094 with other index data for the respective web resources.

Link notes 1094 can include user-generated content that was generated (e.g., composed) to be responsive to and/or about a particular web resource. For example, a link note 1094 may include a review of the content of a web resource (e.g., a review of a story published on a particular web page). The link note 1094 may include details about the web resource provided by one or more users, which may include a breakdown of related topics, a discussion on the credibility of the web resource, a discussion of related works, and/or other details. Link notes 1094 can include text, one or more images, one or more videos, audio, multimodal data, and/or other data. Link notes 1094 can include graphical cards that may include a background and structured foreground content, which may include text, image(s), video(s), widget(s), link(s), animation(s), and/or other data.

Link notes 1094 may be generated based on prompt suggestions provided to a user, which a user may then leverage to craft a link note graphical card. The computing system 1000 can leverage context determination (e.g., determining a context a user is likely to provide a note and/or determining a comment gap and/or content gap for a particular link) to determine an input entry interface (e.g., a link note input entry interface) is to be provided and can leverage a generative model (e.g., a large language model) to generate a prompt based on user data (e.g., user search history and/or user browsing history) and/or content data (e.g., the topic of the content and/or the type of content). For example, a user may be prompted in a search results page, during web resource review, and/or upon the next search instance to provide a note on a particular web resource (and/or other content item). A prompt can be generated based on previous user notes, previously viewed content, the topic of the content, and/or the type of content to provide the user with a prompt that requests information in a format that causes insightful note generation.

Link notes 1094 can provide additional information on a web resource without reviewing the web resource, and the link notes can be provided by other users. The computing system 1000 can determine when to provide link notes prompts to users based on contexts determined to be associated with valuable note intake. For example, particular users may provide more trustworthy and/or more detailed information on a particular topic based on previously obtained knowledge and/or based on previously generated notes. Additionally and/or alternatively, particular content types may be determined to be associated with user commenting and/or user confusion.

The prompt provided to the user can “inspire” a user to provide more detailed information and/or may direct a user to leave a note on a particular topic and/or feature of the web resource. A generative model can process user data and/or content data to generate a predicted prompt. In particular, the generative model can leverage a user's search history, a user's browsing history, a user's previous notes, and/or other user data to generate suggested notes, a question to prompt response, and/or a note template. Alternatively and/or additionally, the generative model can leverage semantic understanding of the web resource, topic classification, content type classification, other notes associated with the web resource, and/or other content data to generate suggested notes, a question to prompt response, and/or a note template.

An input entry interface can provide the predicted prompt to a user. The input entry interface can then obtain inputs (e.g., comment input data) from a user to generate user-generated content descriptive of a link note 1094. In some implementations, a graphical card can be generated based on the link note 1094. The graphical card can include the user-generated content of the link note, user profile identifiers (e.g., a name and/or an image), link information, and/or a graphical background. The link note 1094 (and/or the graphical card) can be stored with an association with the web resource. The stored link note 1094 (and/or the graphical card) can then be obtained in response to one or more users searching for the web resource and/or one or more users interacting with a notes interface.

Link notes 1094 (e.g., link notes obtained from users and/or link notes generated by a generative model) can provide additional information on a web resource, which may inform other users of a relevancy to their request. The link notes 1094 can be provided in a search results page and/or may be displayed in a notes interface that can be accessed from a search results page and/or from the web resource. Link notes 1094 can be provided in graphical cards, in a text panel in-line with a text snippet, and/or in other formats.

In some implementations, the link notes 1094 and/or interactions with the link notes 1094 may be utilized to adjust web resource rankings, web resource tagging, web resource embedding, and/or web resource indexing. For example, in some implementations, the link notes 1094 can be processed to determine the quality of the web resource. The quality determination may be determined based on processing the link notes with one or more machine-learned models (e.g., a sentiment analysis model, a language model, a classification model, etc.). The link notes 1094 may be processed with one or more machine-learned models to determine topics associated with the web resource, determine biases of the web resource, utility of the web resource, and/or the direction of the web resource. The link notes 1094 may be utilized for suggesting additional content, may be embedded for embedding based searches, and/or may be utilized for query suggestions.

Link notes 1094 in the notes interface may be ranked and/or displayed based on interactions, machine-learned model determined quality, responsiveness to a query, a level of detail, and/or other attributes. In some implementations, link notes 1094 generated by a user may be provided to all other users, only users within the user's social network, and/or only user's determined to be associated with the user based on interests, location, and/or activity.

Link notes 1094 can be utilized for a plurality of different content items and may not be limited to web resources. For example, the computing system 1000 can be utilized to generate prompts and/or interfaces for obtaining, inspiring, and/or generating link notes for local files (e.g., on-device documents, images, videos, etc.), intranet files, and/or other content item sources, which may include folders on an external drive, documents on the cloud, etc.

In some implementations, the input interface can include an open ended input interface that provides one or more options for providing user inputs. Alternatively and/or additionally, the input interface can include a plurality of features and/or options for generating user-generated content, which may be utilized for link notes and/or stand alone content. The input interface can include an independent content item user interface that can enable a user to add images, links, and/or different template types of content and can be interactive. The interactive user interface can include an image suggestion, template suggestion, text suggestion, layout suggestion, link suggestion, widget suggestions, template suggestion, and/or other options (e.g., other types of suggestions).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1020 and/or 1040) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 10 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1002 can include a number of applications (e.g., applications 10 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1000.

The central intelligence layer can communicate with a central device data layer. The central device data layer can be a centralized repository of data for the computing system 1000. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 9B depicts a block diagram of an example computing system 150 that performs factual statement determination and factual classification according to example embodiments of the present disclosure. In particular, the example computing system 150 can include one or more computing devices 152 that can be utilized to obtain, and/or generate, one or more datasets that can be processed by a sensor processing system 160 and/or an output determination system 180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 152 (e.g., one or more sensors in the computing device 152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 160. The sensor processing system 160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 162, which may determine a context associated with one or more content items. The context determination block 162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 160 may include an image preprocessing block 164. The image preprocessing block 164 may be utilized to adjust one or more values of an obtained and/or received image to prepare the image to be processed by one or more machine-learned models and/or one or more search engines 174. The image preprocessing block 164 may resize the image, adjust saturation values, adjust resolution, strip and/or add metadata, and/or perform one or more other operations.

In some implementations, the sensor processing system 160 can include one or more machine-learned models, which may include a detection model 166, a segmentation model 68, a classification model 170, an embedding model 172, and/or one or more other machine-learned models. For example, the sensor processing system 160 may include one or more detection models 166 that can be utilized to detect particular features in the processed dataset. In particular, one or more images can be processed with the one or more detection models 166 to generate one or more bounding boxes associated with detected features in the one or more images.

Additionally and/or alternatively, one or more segmentation models 168 can be utilized to segment one or more portions of the dataset from the one or more datasets. For example, the one or more segmentation models 168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 170 can be utilized to process image data, text data, audio data, latent encoding data, multimodal data, and/or other data to generate one or more classifications. The one or more classification models 170 can include one or more image classification models, one or more object classification models, one or more text classification models, one or more audio classification models, and/or one or more other classification models. The one or more classification models 170 can process data to determine one or more classifications.

In some implementations, data may be processed with one or more embedding models 172 to generate one or more embeddings. For example, one or more images can be processed with the one or more embedding models 172 to generate one or more image embeddings in an embedding space. The one or more image embeddings may be associated with one or more image features of the one or more images. In some implementations, the one or more embedding models 172 may be configured to process multimodal data to generate multimodal embeddings. The one or more embeddings can be utilized for classification, search, and/or learning embedding space distributions.

The sensor processing system 160 may include one or more search engines 174 that can be utilized to perform one or more searches. The one or more search engines 174 may crawl one or more databases (e.g., one or more local databases, one or more global databases, one or more private databases, one or more public databases, one or more specialized databases, and/or one or more general databases) to determine one or more search results. The one or more search engines 174 may perform feature matching, text based search, embedding based search (e.g., k-nearest neighbor search), metadata based search, multimodal search, web resource search, image search, text search, and/or application search.

Additionally and/or alternatively, the sensor processing system 160 may include one or more multimodal processing blocks 176, which can be utilized to aid in the processing of multimodal data. The one or more multimodal processing blocks 176 may include generating a multimodal query and/or a multimodal embedding to be processed by one or more machine-learned models and/or one or more search engines 174.

The output(s) of the sensor processing system 160 can then be processed with an output determination system 180 to determine one or more outputs to provide to a user. The output determination system 180 may include heuristic based determinations, machine-learned model based determinations, user selection based determinations, and/or context based determinations.

The output determination system 180 may determine how and/or where to provide the one or more search results in a search results interface 182. Additionally and/or alternatively, the output determination system 180 may determine how and/or where to provide the one or more machine-learned model outputs in a machine-learned model output interface 184. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 160 may be utilized to generate and/or provide an augmented-reality experience and/or a virtual-reality experience 186. For example, the one or more obtained datasets may be processed to generate one or more augmented-reality rendering assets and/or one or more virtual-reality rendering assets, which can then be utilized to provide an augmented-reality experience and/or a virtual-reality experience 186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 188 may be determined based on the output(s) of the sensor processing system 160. For example, a search prompt, a purchase prompt, a generate prompt, a reservation prompt, a call prompt, a redirect prompt, and/or one or more other prompts may be determined to be associated with the output(s) of the sensor processing system 160. The one or more action prompts 188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 160 may be processed with one or more generative models 190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 190 can be trained to process input data and generate model-generated content items, which may include a plurality of predicted words, pixels, signals, and/or other data. The model-generated content items may include novel content items that are not the same as any pre-existing work. The one or more generative models 190 can leverage learned representations, sequences, and/or probability distributions to generate the content items, which may include phrases, storylines, settings, objects, characters, beats, lyrics, and/or other aspects that are not included in pre-existing content items.

The one or more generative models 190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 190 may be stored on-device and/or may be stored on a server computing system. In some implementations, the one or more generative models 190 can perform on-device processing to determine suggested searches, suggested actions, and/or suggested prompts. The one or more generative models 190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 106×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 180 may process the one or more datasets and/or the output(s) of the sensor processing system 160 with a data augmentation block 192 to generate augmented data. For example, one or more images can be processed with the data augmentation block 192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 160 may be stored based on a data storage block 194 determination.

The output(s) of the output determination system 180 can then be provided to a user via one or more output components of the user computing device 152. For example, one or more user interface elements associated with the one or more outputs can be provided for display via a visual display of the user computing device 152.

The processes may be performed iteratively and/or continuously. One or more user inputs to the provided user interface elements may condition and/or affect successive processing loops.

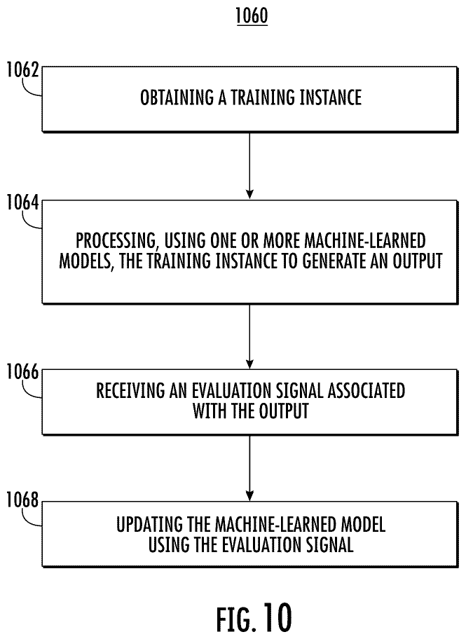

FIG. 10 depicts a flowchart of a method 1060 for training one or more machine-learned models according to aspects of the present disclosure. For instance, an example machine-learned model can include a generative model (e.g., a large language model, a text-to-image generation model, etc.), an embedding model, a classification model, and/or other machine-learned models.

One or more portion(s) of example method 1060 can be implemented by a computing system that includes one or more computing devices such as, for example, computing systems described with reference to the other figures. Each respective portion of example method 1060 can be performed by any (or any combination) of one or more computing devices. Moreover, one or more portion(s) of example method 1060 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1060 can be performed additionally, or alternatively, by other systems.

At 1062, example method 1060 can include obtaining a training instance. A set of training data can include a plurality of training instances divided between multiple datasets (e.g., a training dataset, a validation dataset, or testing dataset). A training instance can be labeled or unlabeled. Although referred to in example method 1060 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1064, example method 1060 can include processing, using one or more machine-learned models, the training instance to generate an output. The output can be directly obtained from the one or more machine-learned models or can be a downstream result of a chain of processing operations that includes an output of the one or more machine-learned models.

At 1066, example method 1060 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning).

The evaluation signal can be a reward (e.g., for reinforcement learning). The reward can be computed using a machine-learned reward model configured to generate rewards based on output(s) received. The reward can be computed using feedback data describing human feedback on the output(s).

At 1068, example method 1060 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1060 can include implementing a number of generalization techniques (e.g., weight decays, dropouts, etc.) to improve the generalization capability of the models being trained.

In some implementations, example method 1060 can be implemented for training a machine-learned model from an initialized state to a fully trained state (e.g., when the model exhibits a desired performance profile, such as based on accuracy, precision, recall, etc.).

In some implementations, example method 1060 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

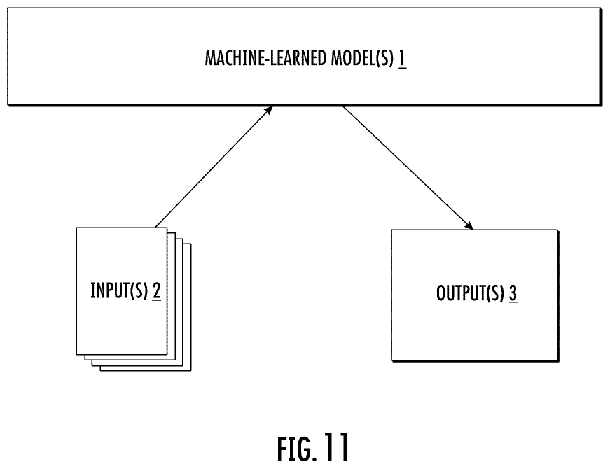

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

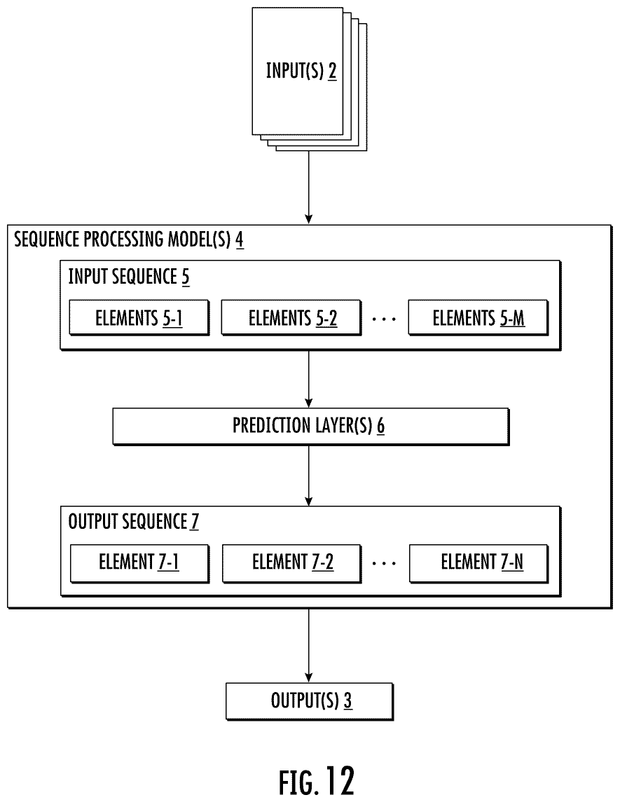

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

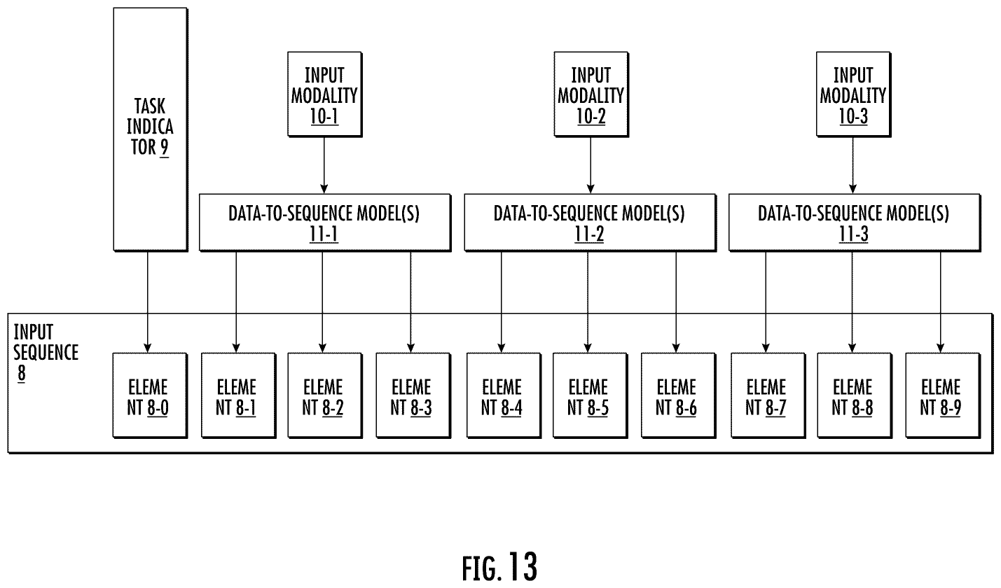

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned embedding and/or learned distribution within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

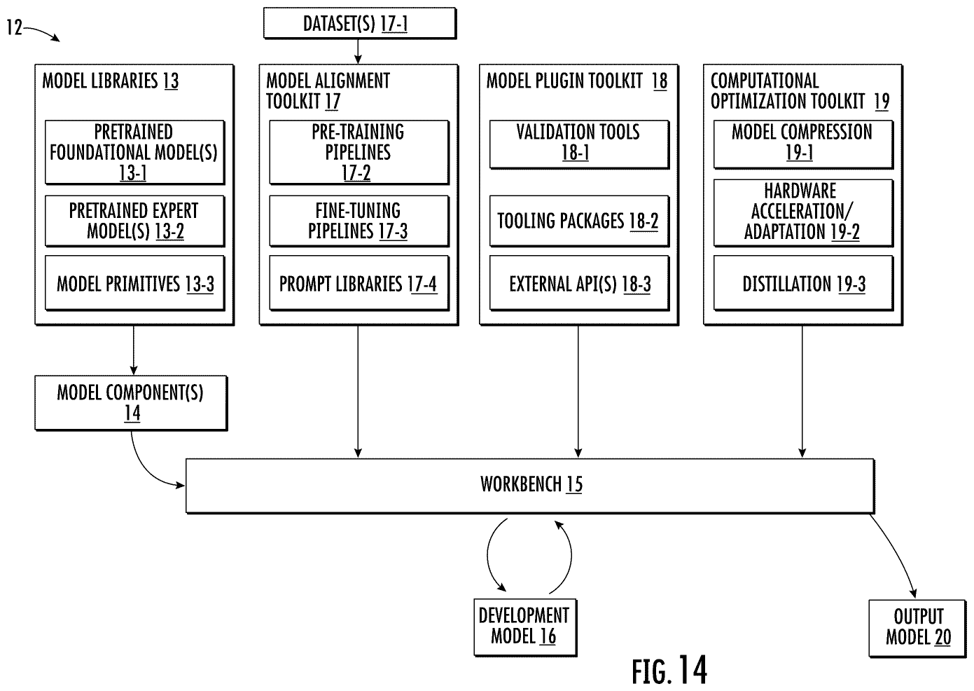

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

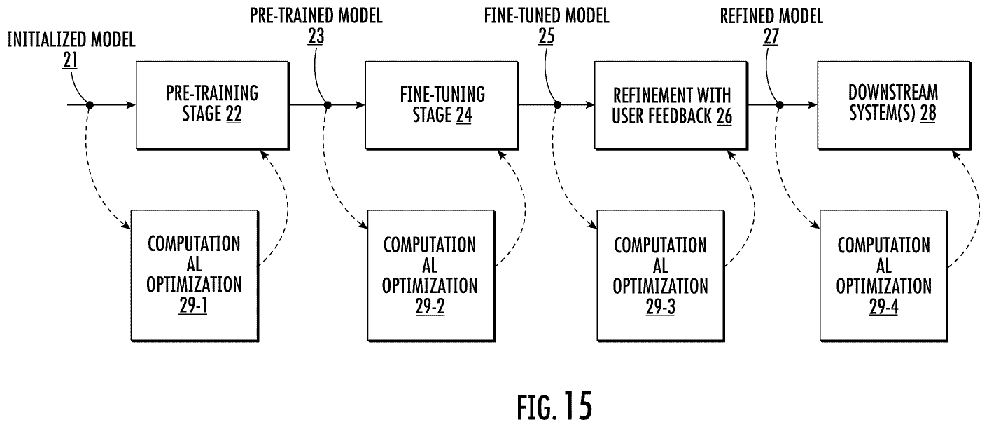

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

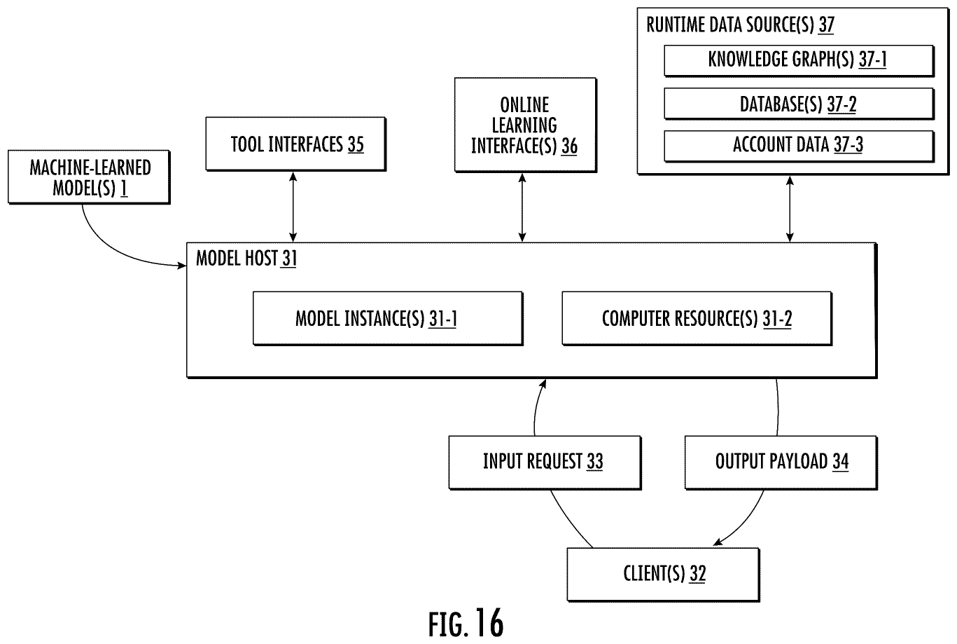

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance.

Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

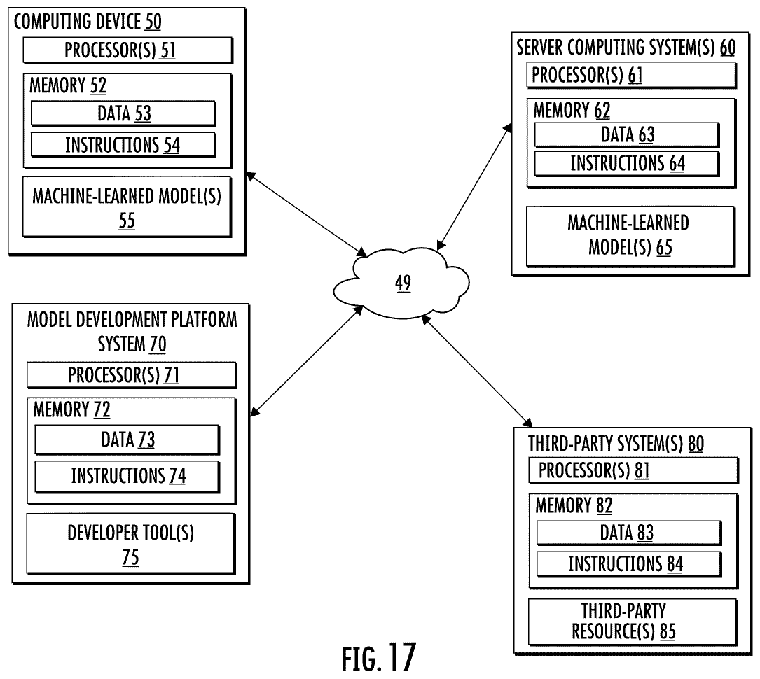

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

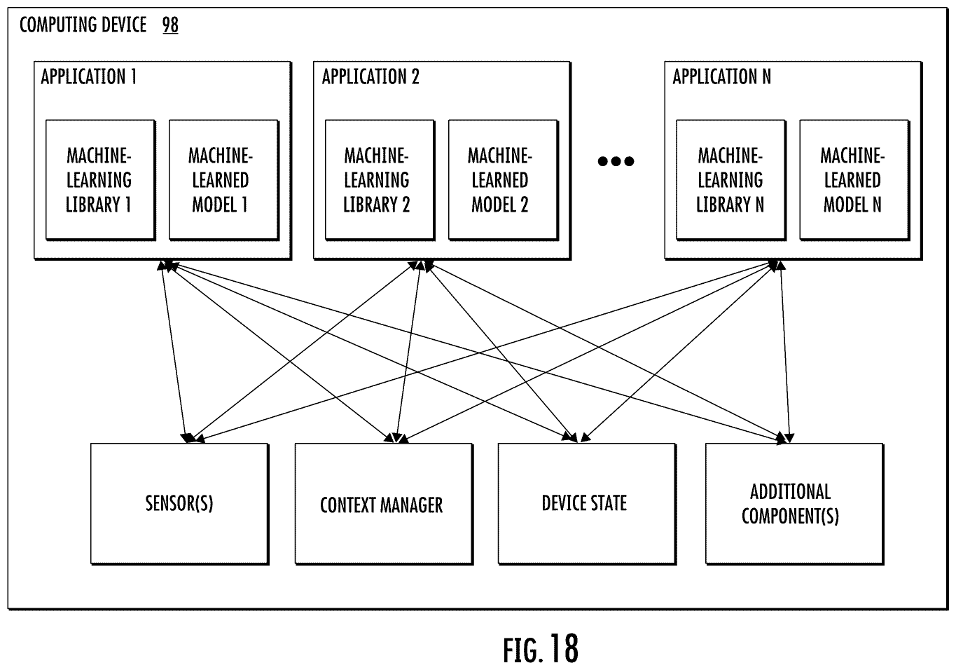

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

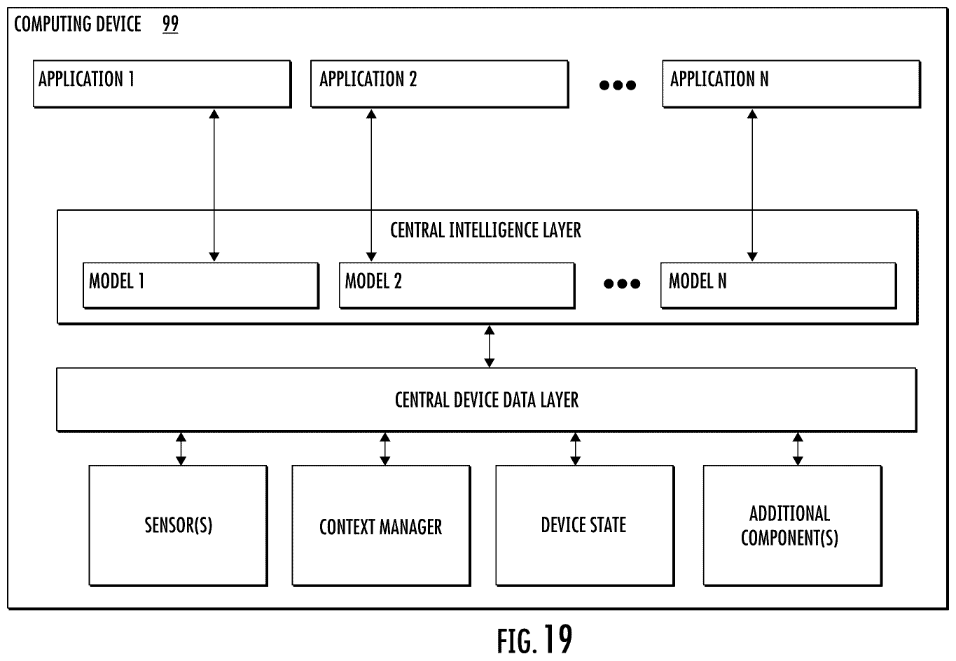

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system for real-time content feedback and suggestion, the system comprising:
one or more processors; and
one or more non-transitory computer-readable media that collectively store instructions that, when executed by the one or more processors, cause the computing system to perform operations, the operations comprising:
obtaining, via a link notes interface, user-generated content data, wherein the user-generated content data comprises a text string input by a user, wherein the link notes interface comprises a user interface that is configured to receive inputs to generate user generated link notes to index with web resources;
processing the user-generated content data with a language model to identify one or more fact statements within the text string input, wherein the language model was trained to parse text and identify text segments associated with a fact being asserted;
generating a factuality classification for each of the one or more fact statements based on querying one or more knowledge databases, wherein generating the factuality classification comprises comparing details from one or more result data sets of the one or more knowledge databases to the one or more fact statements;
determining a resource suggestion based on the one or more result data sets, wherein the resource suggestion comprises information on a topic associated with the one or more fact statements; and
providing the factuality classification and the resource suggestion for display via the link notes interface.

2. The system of claim 1, wherein generating the factuality classification comprises:
generating one or more queries based on the one or more fact statements;
determining the one or more result data sets from the one or more knowledge databases are responsive to the one or more queries; and
generating the factuality classification based on a comparison between the one or more fact statements and the one or more result data sets.

3. The system of claim 1, wherein the operations further comprise iteratively performing fact statement identification, factuality classification determination, resource suggestion determination, and feedback display as additional user generated content inputs are received.

4. The system of claim 1, wherein the user-generated content data is being composed as a link note for a particular web resource.

5. The system of claim 4, wherein the operations further comprise:
determining the particular web resource comprises details associated with the one or more fact statements; and
wherein the factuality classification is determined based at least in part on the details within the particular web resource.

6. The system of claim 5, wherein the details of the particular web resource is weighted based on a determined credibility level of the particular web resource.

7. The system of claim 1, wherein the operations further comprise:
processing the resource suggestion and the one or more fact statements to determine one or more relevant passages of the resource suggestion; and
providing the one or more relevant passages of the resource suggestion for display.

8. The system of claim 1, wherein the operations further comprise:
processing the one or more result data sets and the one or more fact statements with the generative language model to determine the factuality classification and a reasoning text string, wherein the reasoning text string is descriptive of reasoning for the factuality classification; and
providing the reasoning text string for display.

9. The system of claim 1, wherein the one or more result data sets of the one or more knowledge databases are determined based on (i) determining the one or more result data sets of the one or more knowledge databases are associated with the topic of the one or more fact statements and (ii) determining the one or more result data sets are within a recency threshold.

10. The system of claim 1, wherein the operations further comprise:
performing optical character recognition on one or more images of the user-generated content data.

11. A computer-implemented method, the method comprising:
obtaining, by a computing system comprising one or more processors and via a user interface, user-generated content data, wherein the user-generated content data comprises a text string input by a user, wherein the user interface is configured to receive inputs to compose user-generated content;
processing, by the computing system, the user-generated content data with a machine-learned generative language model to identify one or more fact statements within the text string input, wherein the machine-learned generative language model was tuned to parse text and identify text segments associated with a fact being asserted;
generating, by the computing system, a factuality classification for each of the one or more fact statements based on querying one or more knowledge databases, wherein generating the factuality classification comprises comparing details from one or more result data sets of the one or more knowledge databases to the one or more fact statements;
determining, by the computing system, a resource suggestion based on the one or more result data sets, wherein the resource suggestion comprises information on a topic associated with the one or more fact statements; and
providing, by the computing system, the factuality classification and one or more relevant passages of the resource suggestion for display via the user interface.

12. The method of claim 11, further comprising: processing, by the computing system, the resource suggestion and the one or more fact statements with the machine-learned generative language model to determine the one or more relevant passages.

13. The method of claim 11, wherein the factuality classification comprises at least one of true, false, or undetermined.

14. The method of claim 11, wherein the factuality classification comprises a binary classification label and a confidence score.

15. The method of claim 11, further comprising:
processing the resource suggestion and the one or more fact statements to determine the one or more relevant passages of the resource suggestion.

16. The method of claim 11, wherein the one or more result data sets are determined based on being associated with the topic associated with the one or more fact statements and one or more credibility scores associated with the one or more resources of the one or more result data sets.

17. One or more non-transitory computer-readable media that collectively store instructions that, when executed by one or more computing devices, cause the one or more computing devices to perform operations, the operations comprising:
obtaining, via a link notes interface, user-generated content data, wherein the user-generated content data comprises a text string input by a user, wherein the link notes interface comprises a user interface that is configured to receive inputs to generate user generated link notes to index with web resources;
processing the user-generated content data with a language model to identify one or more fact statements within the text string input, wherein the language model was trained to parse text and identify text segments associated with a fact being asserted;
generating one or more factuality classifications for the one or more fact statements based on querying one or more knowledge databases, wherein generating the one or more factuality classifications comprises comparing details from one or more result data sets of the one or more knowledge databases to the one or more fact statements;
determining one or more resource suggestions based on the one or more result data sets, wherein the resource suggestions comprise information on one or more topics associated with the one or more fact statements; and
providing one or more annotations with the user-generated content data, wherein the one or more annotations indicate one or more positions of the one or more fact statements, wherein the one or more annotations further comprise the one or more factuality classifications and the one or more resource suggestions.

18. The one or more non-transitory computer-readable media of claim 17, wherein the one or more annotations comprise underlining the text segments associated with the fact being asserted.

19. The one or more non-transitory computer-readable media of claim 18, wherein the one or more annotations comprise a pop-up overlay interface window that comprises the one or more factuality classifications and the one or more resource suggestions.

20. The one or more non-transitory computer-readable media of claim 17, wherein the one or more annotations comprise highlighting the text segments associated with the fact being asserted.
